(19) United States
(12) Patent Application Publication
(10) Pub. No.: US 2001/0040425 A1
(43) Pub. Date: Nov. 15, 2001

(54) Assembly for supporting a mask frame in a color picture tube

(76) Inventors: Kuen-Dong Ha, Seoul (KR); Dong-Hwan Kim, Suwon-city (KR); Gui-Bae Kim, Seongnam-city (KR)

Correspondence Address: Robert E. Bushnell, Suite 300, 1522 K Street, N.W., Washington, DC, 20005-1202, US

(21) Appl. No.: 09/835,592

(22) Filed: Apr. 17, 2001

(30) Foreign Application Priority Data
Apr. 17, 2000 (KR) 2000/19928

(51) Int. Cl. H01J 29/80

(52) U.S. Cl. 313/407

(57) ABSTRACT

A bracket is provided to couple a mask frame to a stud of a panel in a color picture tube having a tube axis. The mask frame has a rectangular rim in parallel with the tube axis and a flange vertically extending from a rear end of the rectangular rim towards the tube axis. The bracket includes a suspending arm disposed in parallel with the tube axis and provided with a hole coupled to the stud, a fixing arm fixed on the rectangular rim of the mask frame, and a vibration absorber connecting the fixing arm and the suspending arm and having a predetermined length.

### CLAIM OF PRIORITY

This application makes reference to, incorporates the same herein, and claims all benefits accruing under 35 U.S.C. §119 from my application entitled SUPPORT MEMBER FOR MASK FRAME OF CPT filed with the Korean Industrial Property Office on Apr. 17, 2000 and there duly assigned Serial No. 2000/19928.

### BACKGROUND OF THE INVENTION

1. Field of the Invention

The present invention relates to an assembly for supporting a mark frame in a color picture tube and, more particularly, to an assembly for supporting a mask frame and preventing deformation of a shadow mask mounted on the mask frame in a color picture tube.

2. Description of the Related Art

The level of flatness of a screen surface of a color picture tube is accompanied by a flatness of a shadow mask. To improve the quality of the shadow mask, nikel-iron alloy, such as Invar, having a low coefficient of thermal expansion, has been used for making the shadow mask flat. The shadow mask is attached to a mask frame which is mounted inside the color picture tube by a support. However, a spring back occurs after the shadow mask is cast because of the strength of the shadow mask made of Invar. Since the shadow mask made of Invar is weak when subject to mechanical vibrations, the shadow mask may be easily deformed by an external impact exerted on the color picture tube and transferred to the shadow mask through the mask frame and the support, particularly when an outer shock wave is transmitted to a center of the screen. When a mask frame supporting the shadow mask reflects an internal shock wave, the two waves are advanced in opposite directions while overlapping and compensating each other. As a result, the shadow mask might be damaged by breakdown stress caused when magnitudes of a variety of waves generated by an extended impact and reflected by the mask frame are offset to each other or amplified on a portion of the shadow mask assembly.

### SUMMARY OF THE INVENTION

It is an object of the present invention to provide an improved mask frame support and an improved process for supporting a color picture tube.

It is another object to provide a mask frame and process for supporting a color picture tube while absorbing external impacts transmitted to a shadow mask.

It is also object to provide a mask frame support capable of preventing deformation of the shadow mask.

It is still object to provide a mask frame support capable of improving the display quality of a color picture tube.

It is yet another object to provide a mask frame support for a color picture tube that is able to reduce the spring back phenomenon generated by a shadow mask.

It is still yet another objet to provide a mask frame support for a color picture tube able to reduce the breakdown stress generated outside the color picture tube and from a mask frame.

It is a further object to provide a mask frame for supporting for a color picture tube that is able to reduce reflective waves generated by the mask frame.

These and other objects may be achieved by using a support to couple a mask frame to a stud formed on an inner side of a panel of a color picture tube having a tube exhibiting a centrally aligned longitudinal axis. The mask frame may have a rectangular hollow cylinder disposed in parallel with the axis and a flange vertically extending from a rear end of the rectangular frame portion and towards the axis. The support includes a suspending plate disposed in parallel with the axis and provided with a hole coupled to the stud, a fixing plate fixed on the mask frame, and a vibration absorber connected between the rear end of the suspending plate and the fixing plate and having a predetermined length related to the width of the fixing plate and the suspending plate. The fixing plate is aligned in parallel to the axis and fixed to an outer side of the rectangular hollow cylinder of the mask frame while the vibration absorber is placed on a plane having a first distance from the shadow mask, the first distance being greater than a second distance between the shadow mask and the stud.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded view of a shadow mask frame assembly constructed as the principles of the present invention;

FIG. 2 is a partial cross sectional view of a shadow mask frame assembly in a color picture tube constructed as a first embodiment of the present invention;

FIG. 3 is a partial cross sectional view of a shadow mask frame assembly in a color picture tube constructed as a second embodiment of the present invention;

FIG. 4 is an exploded view of a shadow mask frame assembly constructed by a third embodiment of the present invention;

FIG. 5 is a partial cross sectional view of FIG. 4;

FIG. 6 is a partial cross sectional view of a shadow mask frame assembly in a color picture tube constructed as a fourth embodiment of the present invention; and

FIG. 7 is a partial cross sectional view of a shadow mask frame assembly in a color picture tube constructed as a fifth embodiment of the present invention.

### DETAILED DESCRIPTION OF THE INVENTION

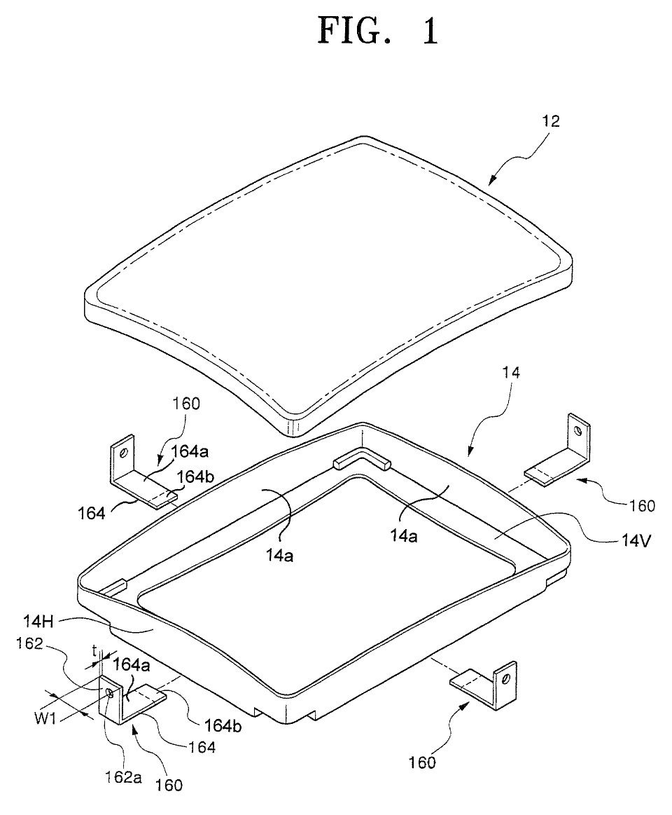

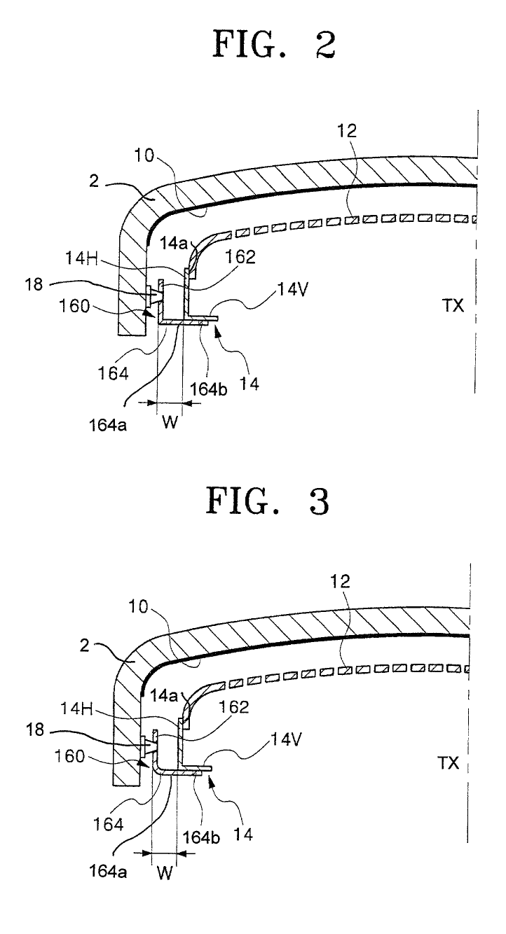

Turning now to the drawings, FIG. 1 shows a shadow mask frame assembly built according to a first embodiment of the present invention, and FIG. 2 shows a partial cross sectional view of the embodiment illustrated by FIG. 1. As shown in FIGS. 1 and 2, a mask frame 14 of a color picture tube like as a cathode ray tube have a shape of a rectangular hollow cylinder having a rectangular rim 14H disposed in parallel with a tube axis TX passing through a longitudinal center of the color picture tube and mask frame 14, a central opening formed inside mask frame 14, and a peripheral flange 14V vertically extending from a rear end of rectangular rim 14a and towards tube axis TX. Shadow mask 12 is welded on an inner surface 14a of a front end of rectangular rim 14H. Several discrete brackets 160 as a support member supporting mask frame 14 within the color picture tube are mounted on at least three sides or corners of mask frame 14 and coupled to a stud 18 to extend radially inwardly from an inner wall 2a of a rectangular glass panel 2.

Since mask frame 14 may be damaged by any vertical movement of a vertical mask surface wave generated by an external impact, each of brackets 160 is designed to absorb and damp vertical mask surface waves. Each bracket 160 includes a suspending arm 162 disposed in parallel to tube axis TX and a connecting arm 164 vertically extending from a rear end of suspending arm 162 toward tube axis TX. Suspending arm 162 is provided with a hole 162a to which stud 18 may be receivingly coupled. Connecting arm 164 has a vibration absorbing length 164a that serves as a vibration absorber, and a distal end 164b integrally extending from vibration absorber 164a. Distal end 164b is attached by welding to an outer surface of peripheral flange 14V of mask frame 14 over the rear end of rectangular portion 14a. Therefore, bracket 160 is L-shaped such that it can absorb an external impact while being adapted to accommodate a vertical mask wave generated by the external impact.

The absorbing effect of the external impact is increased in proportion to a length of vibration absorber 164a. The length W is preferably in a the range of 5-40 mm, and more preferably, in the range of 10-15 mm. Suspending arm 612 is right-angled to connecting arm 164 as shown in FIG. 2, or rounded to the connecting arm 164 as shown in FIG. 3 of a second embodiment.

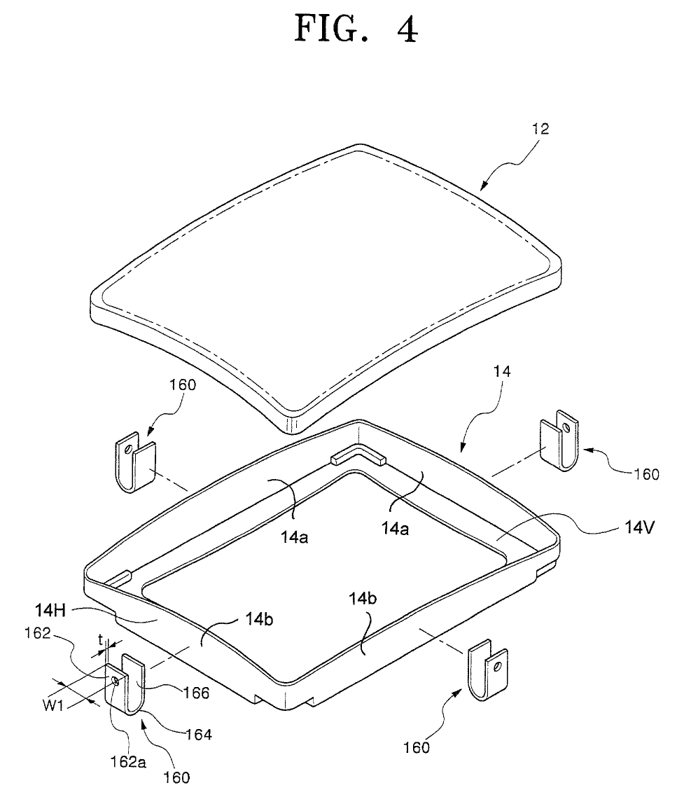

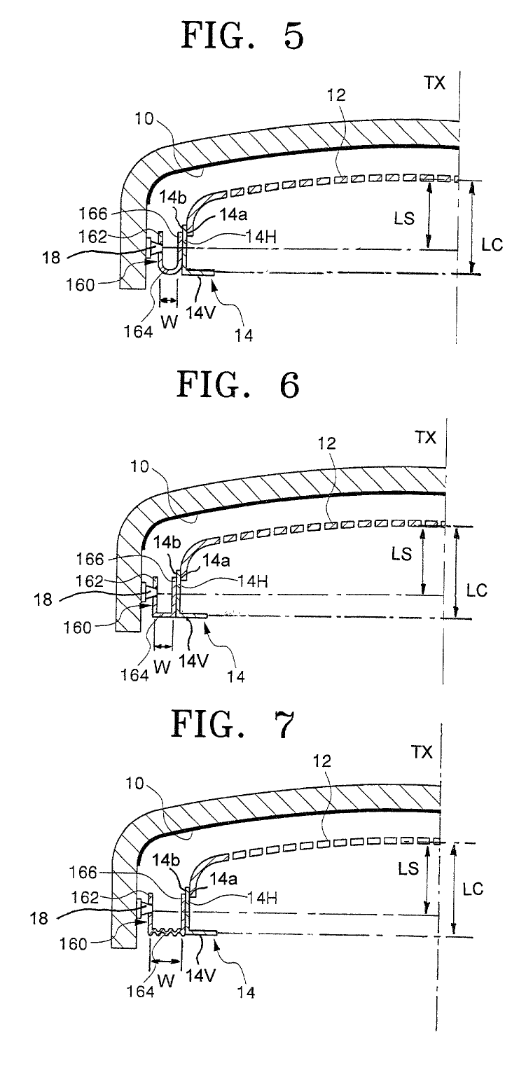

FIGS. 4 and 5 show a third embodiment of a shadow mask frame support assembly having a shadow mask 12 attached to an inner surface 14a of a front end of rectangular rim 14H. As shown in the drawings, a bracket 160 of this embodiment is U-shaped and can absorb and damp the mask surface waves before the external impact is transmitted to the shadow mask frame assembly through bracket 160.

Bracket 160 includes a suspending arm 162 disposed in parallel with the tube axis TX, a fixing arm 166 disposed in parallel with suspending arm 162 and spaced apart from suspending arm 162 by a predetermined distance, and a vibration absorber 164 connecting a rear end of suspending arm 162 to a rear end of fixing arm 166. Suspending arm 162, fixing arm 166, and vibration absorber 164 are flat plates in a single body. Suspending arm 162 and fixing arm 166 are parallel to each other while being perpendicular to vibration absorber 164. Suspending arm 62 is provided with a hole 162a coupled to a stud 18. Fixing arm 166 is attached on an outside surface 14b of rectangular rim 14H of mask frame 14.

The absorbing effect of the external impact is increased in proportion to a distance DL between suspending arm 162 and fixing portion 166. Length W is preferably in the range of 5-40 mm, and more preferably, in the range of 10-15 mm. In order to increase the absorbing effect of the external impact, vibration absorber 164 is disposed to be far from shadow mask 12 by a distance LC greater than a distance LS between shadow mask 12 and stud 18. A plane of shadow mask 12 is substantially parallel to a plane of vibration absorber 164 and a plane on which stud 18 is placed.

Although vibration absorber 164 is arc-shaped in FIG. 5, it may be flat-shaped as shown in FIG. 6 of a fourth embodiment, or wave-shaped as shown in FIG. 7 of a fifth embodiment according to the principle of the present invention. When vibration absorber 164 is wave-shaped, the absorbing and damping effect may be further improved.

If the distance LC between the planes of shadow mask 12 and vibration absorber 164 is less than the distance LS between the planes of shadow mask 12 and stud 18, the vibration absorbing effect will not be increased because the external impact is easily transmitted between suspending arm 162 and fixing arm 164 and between stud 18 and shadow mask 12.

When bracket 160 is disposed between mask frame 14 and the inner wall 2a of panel 2, suspending arm 162 is coupled to stud pin 18 through hole 162a while fixing arm 166 is fixed to the outside surface 14b of rectangular rim 14H of mask frame 14 while vibration absorber 164 is located on the plane spaced apart from shadow mask 12 by distance LC greater than distance LS. The plane on which vibration absorber 164 is located may be the same plane as flange 14V of mask frame 14. For more improved effect of the vibration, a width W1 of the bracket 160 is adjusted compared to a distance W between suspending arm 162 and fixing arm 166.

As described above, the bracket constructed according to the present invention vibrates in a direction parallel to the tube axis TX to offset the vibration generated when the external impact is applied to the shadow mask frame assembly, to avoid reflective waves generated by mask frame, and to reduce the amount of vibration of the shadow mask, thereby preventing the shadow mask from being deformed.

A series of simulations were conducted to test the absorbing effect of the bracket of the present invention. For conducting the simulations, three brackets having different lengths of the connecting arm are used in a shadow mask frame assembly of a 19″ color picture tube.

Table 1 shows simulation results of a shadow mask from assembly having the bracket made according to the principle of the present invention. The bracket is a metal strip having an elastic coefficient of about 100,000-220,000 mPa, a thickness of about 0.5 mm, and a width W1 of about 10 mm. The bracket designed to have three different lengths W of the vibration absorber are tested. “G” represents a unit for a breakdown stress level.

TABLE 1

| | | Present Invention | | |
|---|---|---|---|---|
| | Related Art | W = 5 mm | W = 10 mm | W = 15 mm |
| Breakdown | 9G | 11G | 13G | 15G |
| Stress (G) | | | | |

As shown in the table 1, the bracket of the present invention show markedly improved breakdown stress levels by a maximum of 166% compared to the related art.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An assembly for supporting a mask frame to a stud of a panel in a cathode ray tube having a longitudinal tube axis, comprising:
said mask frame having a rectangular rim disposed in parallel with said tube axis, having a flange vertically extending from a rear end of said rectangular rim toward said tube axis and perpendicular to said tube axis;
a shadow mask having a skirt fixed on an inside surface of a front end of said rectangular rim, having a first plane perpendicular to said tube axis and passing a central surface of said shadow mask;
a bracket having a suspending arm joined by a connecting arm to a fixing arm, said suspending arm and said fixing arm spaced apart from each other and disposed in parallel with said tube axis;
said suspending arm being provided with a hole coupled to said stud;
said fixing arm fixed on an outside surface of said rectangular rim of said mask frame; and
said connecting arm having a second plane substantially parallel to said first plane of said shadow mask and spaced apart from said first plane of said shadow mask by a first distance, said first distance being greater than a second distance between said first plane of said shadow mask and a third plane passing a center line of said stud.

2. The assembly of claim 1, wherein said connecting arm is perpendicular to both said fixing arm and said suspending arm.

3. The assembly of claim 2, said connecting arm having a length of about 5-40 mm.

4. The assembly of claim 1, said connecting arm having a characteristic for absorbing vibration transmitted from both said mask frame and said panel and offsetting the vibration.

5. The assembly of claim 1, wherein said suspending arm, said connecting arm, and said fixing arm are made in a single body and a flat plate.

6. The assembly of claim 1, said connecting arm being wave-shaped.

7. The assembly of claim 1, said suspending arm and said fixing arm being flat plates spaced apart from each other by about 5-40 mm.

8. The assembly of claim 1, further comprising a bent formed between said suspending arm and said connecting arm and being round.

9. The assembly of claim 1, said flange of said mask frame placed on said second plane of said connecting arm.

10. The assembly of claim 1, said skirt of said shadow mask being closer to said third plane of said stud than said second plane of said connecting arm.

11. An assembly in a picture tube having a longitudinal tube axis, comprising:
a mask frame being a rectangular rim parallel to said tube axis;
a shadow mask having a skirt fixed on an inside surface of said rectangular rim, having a first plane perpendicular to said tube axis and passing a central surface of said shadow mask;
a stud formed on and extending inwardly from a sidewall of a panel of said picture tube;
a bracket having a suspending arm joined by a connecting arm to a fixing arm, being made in a single body, said suspending arm and said fixing arm being flat plates and parallel to each other;
said fixing arm fixed on an outside surface of said rectangular rim of said mask frame opposite to said shadow mask while said suspending arm coupled to said stud; and
said connecting arm having a second plane substantially parallel to said first plane and spaced apart from said first plane by a first distance greater than a second distance between said first plane of said shadow mask and a third plane passing a center line of said stud.

12. The assembly of claim 11, said suspending arm and said fixing arm being parallel to said tube axis and perpendicular to said connecting arm.

13. The assembly of claim 11, said connecting arm being U shaped.

14. The assembly of claim 11, said connecting arm being wave shaped.

15. The assembly of claim 11, said connecting arm having a characteristic for absorbing vibration transmitted from both said panel and said mask frame and offsetting said vibration.

16. The assembly of claim 11, said connecting arm and said fixing arm being right-angled to each other.

17. The assembly of claim 11, said bracket having a bent formed between connecting arm and any one of said suspending arm and said fixing portion.

18. The assembly of claim 11, said connecting arm having a length of about 5-40 mm.

19. The assembly of claim 11, said suspending arm and said fixing arm being spaced apart from each other by about 5-40 mm.

20. The assembly of claim 11, said bracket having an opening formed between free ends of said suspending arm and said fixing arm, said opening opposite to said connecting arm, said stud disposed between said opening and said connecting arm.
